(19) United States
(12) Patent Application Publication
(10) Pub. No.: US 2025/0106566 A1
(43) Pub. Date: Mar. 27, 2025

(54) Dynamic Microphone Configuration

(71) Applicant: Shure Acquisition Holding, Inc., Niles, IL (US)

(72) Inventor: Bijal R. Joshi, Schaumburg, IL (US)

(21) Appl. No.: 18/830,984

(22) Filed: Sep. 11, 2024

Related U.S. Application Data
(60) Provisional application No. 63/540,443, filed on Sep. 26, 2023.

(51) Int. Cl. H04R 19/04

(52) U.S. Cl. CPC H04R 19/04; H04R 2201/003; H04R 2430/21

(57) ABSTRACT

Aspects of the disclosure relate to signal processing of audio received via multiple microphones. Audio received via multiple microphones may be spectrally processed to reduce interference and/or noise. For example, audio received via a first microphone may be processed with a transfer function which depends on a frequency response of the first microphone and a second microphone. The processed audio may be combined with audio received via the second microphone. The first microphone may be an omnidirectional microphone and the second microphone may be a directional microphone.

### CROSS-REFERENCE TO RELATED APPLICATION

This application claims the benefit of U.S. Provisional Patent Application No. 63/540,443, filed on Sep. 26, 2023, which is fully incorporated herein by reference.

### TECHNICAL FIELD

Aspects of the disclosure relate to microphone configuration using multiple microphones for improved audio performance.

### BACKGROUND

Multiple microphone types, employing different technologies, are commercially available (e.g., dynamic microphones, condenser microphones, ribbon microphones, micro-electromechanical systems (MEMS) microphones, etc.). A microphone technology may have associated advantages that make it suitable for specific applications. For example, dynamic microphones are rugged, do not require a power source to generate an output, and can operate well even in environments with high sound pressure levels. As such, dynamic microphones are suitable for a wide range of applications, from everyday use to live performances. MEMS microphones have a small footprint, low power consumption, and provide an omnidirectional pickup pattern. MEMS microphones are most suitable for space constrained applications or where sound needs to be captured from a wider area.

### SUMMARY

The following summary presents a simplified summary of certain features. The summary is not an extensive overview and is not intended to identify key or critical elements.

Various examples herein describe spectral processing and/or beamforming for enhancement of received audio at a microphone assembly comprising multiple microphones. An example microphone assembly may comprise at least two microphones. For example, a first (e.g., primary) microphone may be a microphone with a cardioid pickup pattern (e.g., a condenser microphone or a dynamic microphone). A second (e.g., secondary) microphone may be a microphone with an omnidirectional pickup pattern (e.g., MEMS microphone). Spectral processing of audio signals as received, at a processor, from the first microphone and the second microphone may comprise converting received audio signals to frequency domain. Audio signals received from the second microphone may be processed using a transfer function to generate adjusted audio signals. The transfer function may be based on a frequency response of the first microphone and a frequency response of the second microphone. The adjusted audio signals may be subtracted from audio signals as received from the first microphone. Spectral subtraction as described herein may be used to narrow a cardioid pickup pattern of the first microphone and/or for reduction of noise in audio output from the microphone assembly.

Additional aspects described herein may enable dynamic adjustment of a microphone pickup pattern. For example, based on characteristics of received audio (e.g., directions of received audio), audio signals from the microphones may be spectrally processed (e.g., added or subtracted) to reflect bidirectional, omnidirectional, and/or supercardioid pickup patterns.

Other aspects described herein relate to application of beamforming techniques to improve a sensitivity of a microphone assembly. Prior to combining audio signals, as received from multiple microphones, to obtain a beamformed output, a transfer function may be applied to an audio signal from a microphone to reflect a frequency response of another microphone in the direction of beamforming. Application of the transfer function to the audio signal may enable a more accurate beamformed output even if microphones being used in the microphone array have different frequency responses and/or are of different types. These and other features and advantages are described in greater detail below.

### BRIEF DESCRIPTION OF THE DRAWINGS

The present disclosure is illustrated by way of example and not limited in the accompanying figures in which like reference numerals indicate similar elements and in which:

FIG. 1 shows an example microphone assembly.

FIG. 2A shows an example handheld microphone assembly comprising multiple separate microphones in a microphone array,

FIG. 2B shows an example podcast microphone assembly comprising multiple separate microphones in a microphone array,

FIG. 3 shows a block diagram illustrating various modules of a microphone assembly,

FIG. 4A shows an example method for interference reduction using spectral subtraction,

FIG. 4B shows an example cardioid shape of a pickup pattern of a microphone assembly,

FIG. 4C shows an example of a narrower cardioid-shaped pickup pattern of a microphone assembly,

FIG. 5 shows an example method for noise reduction,

FIG. 6 shows an example method for adjusting a microphone pickup pattern,

FIG. 7A shows an example method for beamformed audio reception at a microphone assembly,

FIG. 7B shows an example pickup pattern of a microphone assembly without beamforming, and

FIG. 7C shows an example of a pickup pattern of a microphone assembly that uses beamforming.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure. It is noted that various connections between elements are discussed in the following description. It is noted that these connections are general and, unless specified otherwise, may be direct or indirect, wired or wireless, and that the specification is not intended to be limiting in this respect.

Microphone assemblies often comprise a microphone array with a plurality of microphones. Different types of microphones may be used in a single microphone array to provide enhanced performance. Various examples herein describe the use of a microphone array to obtain benefits such as adjustment of microphone pickup patterns, noise reduction, directionality, and beamforming. For example, a spectral subtraction technique may be used to narrow a cardioid shape pickup pattern generated by one or more microphones (e.g., non-MEMS microphones, such as dynamic microphones and/or condenser microphones). At least one microphone in the microphone array may be a MEMS microphone. A transfer function may be applied to a signal generated by the MEMS microphone to match a frequency response of a non-MEMS microphone in the array. Processed signal from the MEMS microphone may be subtracted from a signal generated by the non-MEMS microphone to generate an output signal. The output signal may correspond to a narrower cardioid microphone pickup shape than that of the non-MEMS microphone, thereby reducing interference from sound sources that are not in the direction of a desired audio source.

Spectral subtraction may also be used for noise reduction. For example, noise may be picked up by the MEMS microphone. A transfer function may be applied to a noise signal generated by the MEMS microphone to match a frequency response of the non-MEMS microphone in the array. Processed signal from the MEMS microphone may be subtracted from a signal generated by the non-MEMS microphone to generate an output signal with reduced noise.

In some examples, a spectral addition technique may be used to increase a range of the non-MEMS microphone beyond a conventional cardioid pattern. For example, the processed signal from the MEMS microphone may be added to a signal generated by the non-MEMS microphone to generate an output signal with a wider range.

Beamforming may be used to process signals generated by the microphone array. Beamforming, based on received signals from the non-MEMS microphone(s) and the MEMS microphone(s), may be performed after signals generated by the MEMS microphone(s) are processed using transfer function(s) to match the frequency response(s) of the non-MEMS microphones.

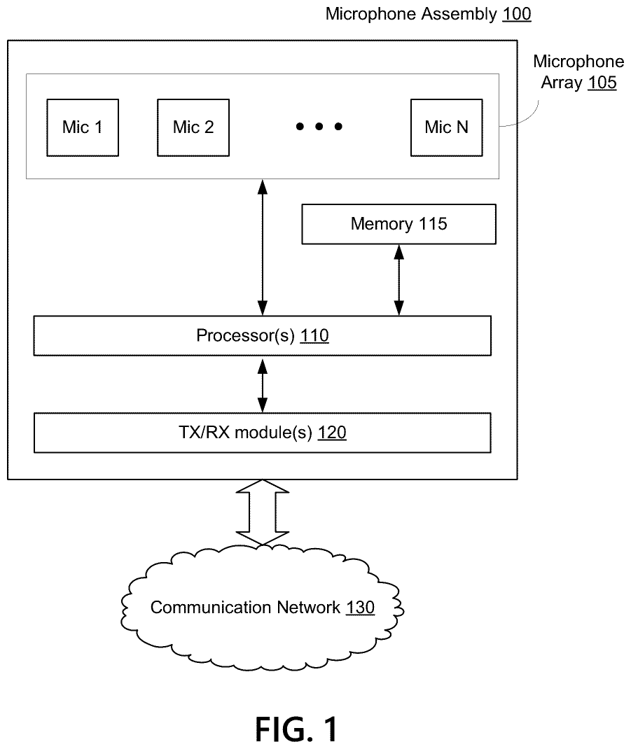

FIG. 1 shows an example microphone assembly 100. The microphone assembly 100 may comprise a microphone array 105, one or more processors 110 (e.g., one or more of physical layer (PHY) processor(s), medium access control (MAC) processor(s), higher layer processor(s), etc.), transmit/receive (TX/RX) module(s) 120, and/or memory 115. One or more data buses, wires, and/or conducting paths (e.g., printed circuit board traces) may interconnect the microphone array 105, the processor(s) 110, the TX/RX module(s) 120, and/or the memory 115. The microphone assembly 100 may communicate, via one or more communication protocols, with one or more other devices (e.g., via a communication network 130).

The various components of the microphone assembly 100 may be implemented using one or more integrated circuits (ICs), software, or a combination thereof, configured to operate as discussed below. For example, the various processors 110 (e.g., one or more of the PHY processor(s), the MAC processor(s), the higher layer processor(s)), the TX/RX module(s) 120, and the memory 115, may be implemented, at least partially, on a single IC or multiple ICs.

Messages transmitted from and/or received by the microphone assembly 100 may be encoded in one or more MAC data units and/or PHY data units. The MAC processor(s) and/or the PHY processor(s) of the microphone assembly 100 may be configured to generate data units, and process received data units, that conform to any suitable wired and/or wireless communication protocol. The data units may correspond to audio data (e.g., as generated based on microphone array output and further processed by the higher layer processor(s)) and/or control information (e.g., for coordinating communication via one or more communication protocols used by devices in the communication network 130). For example, the MAC processor(s) may be configured to implement MAC layer functions, and the PHY processor(s) may be configured to implement PHY layer functions corresponding to a communication protocol. The MAC processor(s) may, for example, generate MAC data units (e.g., MAC protocol data units (MPDUs)) based on operations performed by the higher layer processor(s) (e.g., on the microphone array output), and forward the MAC data units to the PHY processor(s). The PHY processor(s) may, for example, generate PHY data units (e.g., PHY protocol data units (PPDUs)) based on the MAC data units. The generated PHY data units may be transmitted via the TX/RX module(s) to one or more other devices in a communication network 130. Similarly, the PHY processor(s) may receive PHY data units (e.g., configuration/control messages, as sent by one or more other devices in the communication network 130) via the TX/RX module(s) 120, extract MAC data units encapsulated within the PHY data units, and forward the extracted MAC data units to the MAC processor(s). The MAC processor(s) may then process the MAC data units (e.g., as forwarded by the PHY processor(s)) and forward the processed MAC data units to the higher layer processor(s) for additional processing.

The higher layer processor(s) may implement one or more other layers of the OSI model (e.g., network layer, transport layer, session layer, presentation layer, and/or application layer) representing the operations of the microphone assembly 100. The higher layer processor(s) may process data units for transmission via the MAC processor(s) and the PHY processor(s), and/or process data units as received via the PHY processor(s) and the MAC processor(s).

The memory 115 may comprise any memory such as a random-access memory (RAM), a read-only memory (ROM), a flash memory, or any other electronically readable memory, or the like. The processors 110 (e.g., one or more of the PHY processor(s), the MAC processor(s), the higher layer processor(s)), the TX/RX module(s) 120, and/or other component/modules of the microphone assembly 100 may be configured to execute machine readable instructions stored in the memory 115 to perform the various operations described herein. The TX/RX module(s) 120 may comprise components (mixers, amplifiers, drivers, antennas, etc.) for wired/wireless transmission and/or reception of signals (e.g., audio packets, control information) via the communication network 130. Communication via the communication network 130 may comprise transmission and/or reception of electrical and/or electromagnetic signals that may comprise data (e.g., audio data, or any other type of data) and/or control information.

Communications between components of the microphone assembly 100 and/or between the microphone assembly 100 and one or more other devices in the communication network may be via hardware and/or software interfaces using one or more communication protocols (e.g., proprietary and/or non-proprietary communication protocols). The communication protocols may define/codify operation of one or more layers in an Open Systems Interconnection (OSI) model that enable interconnection between and interoperability of multiple devices, applications, and/or systems forming the communication system 100. For example, devices in connected via the communication network 130 may use one or more of Bluetooth protocol(s), Zigbee protocol(s), Institution of Electrical and Electronics Engineers (IEEE) 802.11 Wi-Fi protocol(s), 3^{rd} Generation Partnership Project (3GPP) cellular protocol(s), local area network (LAN) protocol(s), hypertext transfer protocols (HTTP), universal serial bus (USB) protocol(s), Ethernet protocol(s), and/or any other wireless/wired communication protocol, to send and receive audio and/or control information. In at least some examples, audio transmissions from the microphone assembly may be (e.g., additionally or alternatively) in the form of analog audio signals.

In an example, the communication between the devices in the communication network 130 may be via wireless channels that are designated as industrial, scientific, and medical (ISM) bands defined by the International Telecommunication Union (ITU) Radio Regulations (e.g., a 2.4 GHz-2.5 GHz band, a 5.75 GHz-5.875 GHz band, a 24 GHz-24.25 GHz band, and/or a 61 GHZ-61.5 GHz band, etc.). Additionally, or alternatively, the communication between the devices in the communication network 130 may be via (e.g., one or more channels within) a very high frequency (VHF) band (e.g., 30 MHz-300 MHz band), via (e.g., one or more channels within) an ultra-high frequency (UHF) band (e.g., 300 MHz-3 GHZ), and/or any other frequency/frequency range.

The microphone array 105 may comprise a plurality of microphones. For example, the microphone array may comprise different types of microphones (e.g., dynamic microphones, condenser microphones, ribbon microphones, MEMS microphones, etc.). As further described herein, the output from the various microphones comprising the microphone array may be processed to enable interference reduction, noise reduction, beamforming, and/or modification of microphone pickup pattern.

Different microphone types may have different associated properties, advantages, and disadvantages. For example, condenser microphones and dynamic microphones may have a certain degree of directivity but may still be susceptible to audio or noise from directions that are orthogonal to the direction of peak sensitivity. MEMS microphones, while being omnidirectional, have a small footprint. Various examples herein describe microphone assemblies, comprising multiple types of microphones, and associated signal processing procedures. Integration of different microphone types in a single microphone assembly may enable flexible application of advantageous properties of a specific type of microphone, while minimizing any disadvantages via the use of other microphone types. Various examples described herein enable improved directionality, noise reduction, operational flexibility, among other advantages.

For example, as further described herein, a directionality of a condenser microphone or a dynamic microphone may be improved by the use of one or MEMS microphones in a microphone assembly. Output of the MEMS microphone(s) may be spectrally subtracted from an output from the condenser microphone or dynamic microphone to generate a narrower cardioid pickup pattern and reduce interference from audio sources orthogonal to microphone assembly. Similarly, spectral subtraction may also be used for noise reduction based on audio signals as picked up the MEMS microphone(s). The omnidirectional pickup pattern of the MEMS microphone(s) may enable uniform noise reduction irrespective of a location of the audio source. Other examples described herein enable flexible configuration of a same microphone assembly to obtain, as needed and via the use of different signal processing algorithms, increased directionality, noise reduction, beamforming capability, and/or omnidirectional pickup capability.

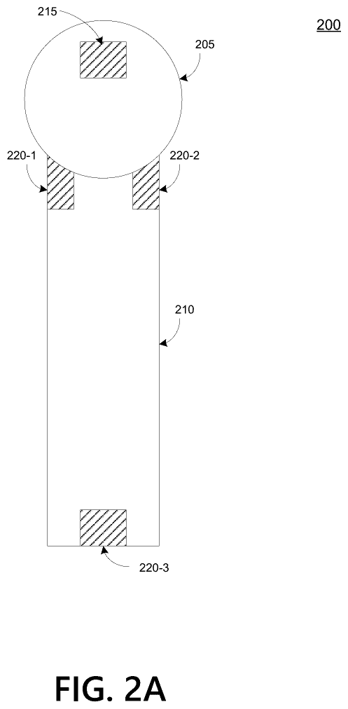

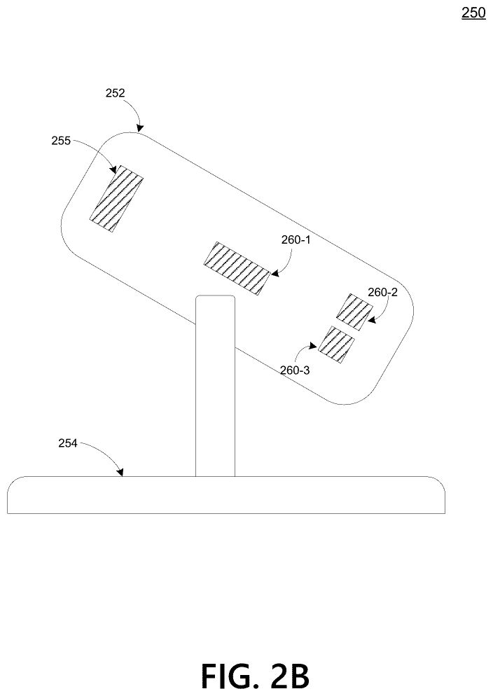

FIG. 2A shows an example handheld microphone assembly 200 comprising multiple separate microphones in a microphone array. The microphone assembly 200 may comprise a primary microphone 215 (e.g., on a microphone head 205) and one or more secondary microphones 220 (e.g., microphones 220-1, 220-2, and/or 220-3) located on the side and rear (e.g., on a microphone handle 210) of the microphone assembly 200. In an example, the primary microphone 215 may be a dynamic microphone or a condenser microphone (or any other type of microphone with a cardioid pickup pattern). The one or more of the secondary microphones 220 may be MEMS microphones (or any other type of microphone with an omnidirectional pickup pattern). The output from the secondary microphones 220 may be used to reduce interference and/or noise (e.g., from audio sources to the side or the back of the microphone assembly 200) from audio as picked up by the primary microphone 215, and/or to modify a pickup pattern of the microphone assembly 200. Additionally, or alternatively, the output from the primary microphone 215 and one or more secondary microphones 220 may be temporally processed for beamformed audio reception. While FIG. 2A shows three secondary microphones 220, the microphone assembly 200 may comprise any quantity of secondary microphones 220 (e.g., one, two, four, etc.).

FIG. 2B shows an example microphone assembly 250 comprising multiple separate microphones in a microphone array. The microphone assembly 250 may correspond to a non-handheld microphone assembly, such as a podcast microphone assembly, a stand-based microphone assembly, and/or the like. The microphone assembly 250 may comprise a primary microphone 255 located on the front of the microphone head 252 and one or more secondary microphones 260 (e.g., microphones 260-1, 260-2, and/or 260-3) located on the side and rear of the microphone head 252. The microphone head 252 may be mounted on a stand 254. In an example, the primary microphone 255 may be a dynamic microphone or a condenser microphone (or any other type of microphone with a cardioid pickup pattern). One or more of the secondary microphones 260 may be MEMS microphones (or any other type of microphone with an omnidirectional pickup pattern). The output from the secondary microphones 260 may be used to reduce interference and/or noise (e.g., from audio sources to the side or the back of the microphone assembly 250) from audio as picked up by the primary microphone 255 and/or to modify a pickup pattern of the microphone assembly 250. Additionally, or alternatively, the output from the primary microphone 255 and one or more secondary microphones 260 may be temporally processed for beamformed audio reception. While FIG. 2B shows three secondary microphones 260, the microphone assembly 250 may comprise any quantity of secondary microphones 260 (e.g., one, two, four, etc.).

For modification of a pickup pattern of the microphone assembly, output of one or more secondary microphones 260 may be spectrally added to the output of the primary microphone 255 to generate a combined audio signal. Spectral addition may be used, for example, if audio from multiple sources needs to be picked up by the microphone assembly 250. In one such application scenario, at least one of the secondary microphones 260 (e.g., microphone 260-3 located on the rear of the microphone assembly 250) may be another dynamic microphone (or any other type of microphone with a cardioid pickup pattern). Output from the microphone 260-3 may be spectrally added to the output of the primary microphone 255 to generate a combined audio signal. This mode may be used to capture audio of a conversation between two speakers.

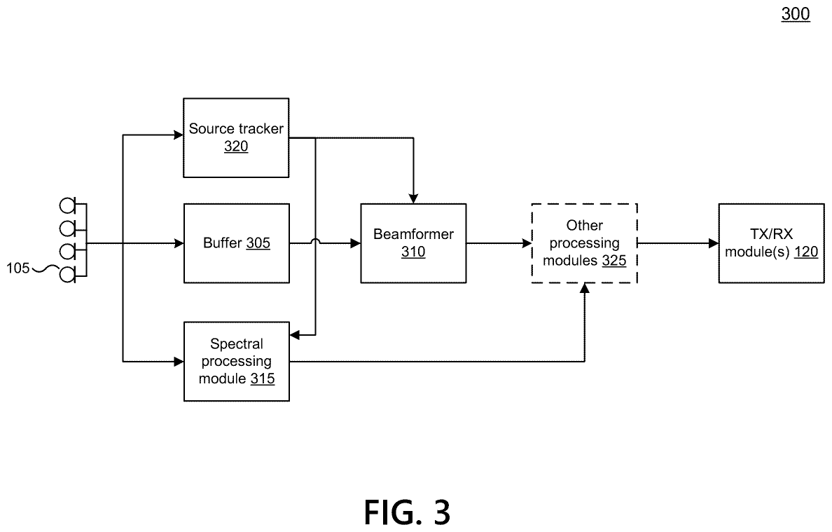

FIG. 3 shows a block diagram 300 illustrating various modules of a microphone assembly. The microphone assembly may comprise the microphone array 105, a buffer 305, a beamformer 310, spectral processing module 315, a source tracker 320, one or more other processing modules 325, and the TX/RX module(s) 120.

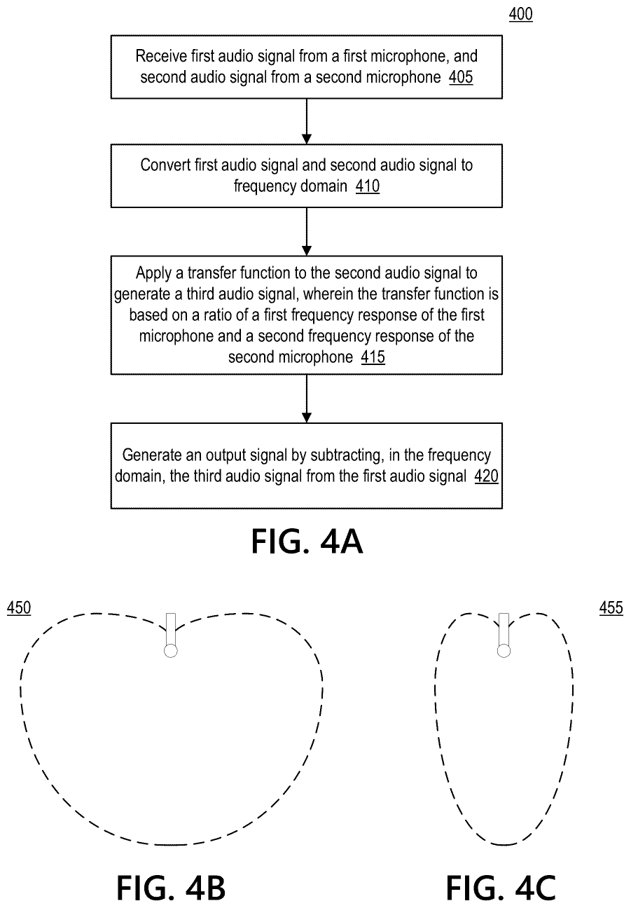

The spectral processing module 315 may perform spectral (e.g., frequency domain) processing on received audio from the microphone array 105. For example, the spectral processing module 315 may perform spectral subtraction (e.g., for reduction of interference and/or noise), spectral addition (e.g., for processing audio from multiple sources), etc. Additional details associated with spectral processing of audio as performed by the spectral processing module 315 are described with reference to FIGS. 4, 5, and 6.

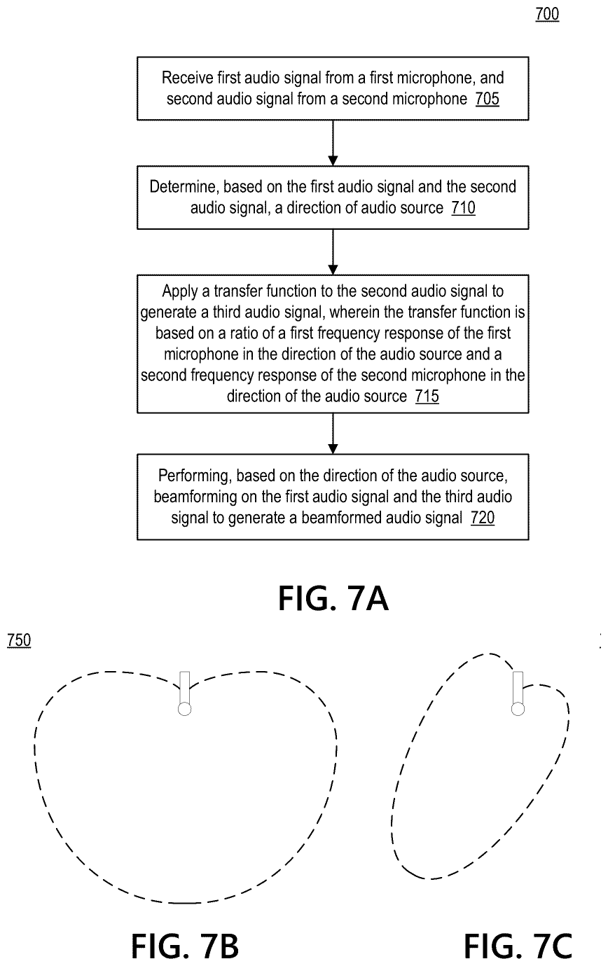

The source tracker 320 may determine the direction of an audio source. The source tracker may indicate the determined direction of the audio source to the beamformer 310. The source tracker 320 may determine the direction of the audio source using one or more techniques. For example, the source tracker 320 may use the time difference of arrival (TDOA) method and/or a triangulation method to determine the direction of the audio source. Additionally, or alternatively, the source tracker 320 may use one or more other methods to determine the direction of the audio source. The beamformer 310 may use the determined direction to perform beamforming on audio received via the microphone array. Additional details associated with beamforming as performed by the beamformer 310 are described with reference to FIGS. 7A, 7B, and 7C.

The buffer 305 may introduce a delay in transmission of the audio signals from the microphone array 105 to the beamformer 310. The buffer 403 may introduce a same delay to audio signals captured by all the microphones in the microphone array 105. The buffer 305 may comprise a first in, first out buffer that may be used to store received audio signals prior to sending the audio signals to the beamformer. The delay may be applied to enable the source tracker to complete the source tracking process and determine the direction of the audio source prior to the beamformer 310 performing beamforming based on the direction of the audio source.

In at least some examples, the source tracker may also indicate the determined direction of the audio source to the spectral processing module 315. The spectral processing module 315 may use the determined direction of the audio source to perform noise reduction, spectral addition, and/or modification of the pickup pattern of the microphone assembly.

The other processing module(s) 325, which may be optionally included in the microphone assembly, may perform one or more additional processing steps. For example, the other processing module(s) 325 may convert a received frequency domain signal (e.g., from the spectral processing module 315) and convert it to a time domain signal for transmission. The other processing module(s) 325 may comprise sampling, quantization, and/or packetization modules for conversion of received analog signals to digital data for transmission and/or storage. The other processing module(s) 325 may comprise amplifiers/drivers for transmission of processed audio signals via the TX/RX module(s) 120.

FIG. 4A shows an example method 400 for interference reduction using spectral subtraction. The interference reduction may be obtained by narrowing down a cardioid pickup pattern of a first microphone (e.g., a condenser microphone, a dynamic microphone, any other microphone with a cardioid or non-cardioid pickup pattern) of a microphone assembly using signals generated by a second microphone (e.g., a MEMS microphone, any other microphone with an omnidirectional pickup pattern) of the microphone assembly. For example, the first microphone may be a primary microphone (e.g., microphone 215, 255), and the second microphone may be a secondary microphone (e.g., microphone 220, 260). The second microphone may be located to a side that is away from the direction of a desired audio source to be captured by the first microphone. In an example, the method 400 may be performed by the spectral processing module 315.

At step 405, a processor (e.g., the spectral processing module 315) may receive a first audio signal from the first microphone and a second audio signal from the second microphone. At step 410, the processor may convert the first audio signal and the second audio signal to the frequency domain. Conversion to the frequency domain may comprise the use of a Fourier transform technique (e.g., discrete Fourier transform (DFT), fast Fourier transform (FFT)). Y₁(ω) may the frequency domain representation of the first audio signal and Y₂(ω) may be the frequency domain representation of the second audio signal, where ω=2πf, and f is the frequency.

At step 415, the processor may apply a transfer function k(ω) to the second audio signal Y₂(ω) to generate a third audio signal Y₃(ω). The transfer function k(ω) may be used to match the second audio signal Y₂(ω) to a first frequency response of the first microphone. The first frequency response of the first microphone may be in a direction from which interference is to be reduced. For example, if the first frequency response of the first microphone in the direction of the interference is H₁(ω) and a second frequency response of the second microphone in the direction of the interference is H₂(ω):

$$k ( ω ) = \frac{{H}_{1} ( ω )}{{H}_{2} ( ω )} \qquad Equation ( 1 )$$

Frequency response of a microphone may represent a signal (e.g., voltage, current) amplitude and/or phase, as output by the microphone, as a function of an input audio frequency. The third audio signal Y₃(ω) may be determined as:

$${Y}_{3} ( ω ) = k ( ω ) {Y}_{2} ( ω ) \qquad Equation ( 2 )$$

The third audio signal may correspond to an estimated interference that may have been picked up by the first microphone from a direction from which interference is to be reduced.

At step 420, the processor may generate an output signal Yₒᵤₜ(ω) by subtracting the third audio Y₃(ω) from the first audio signal Y₁(ω). For example, the output signal Yₒᵤₜ(ω) may be determined as:

$${Y}_{out} ( ω ) = {Y}_{1} ( ω ) - {Y}_{3} ( ω ) \qquad Equation ( 3 )$$

The processor may send the output signal to the other processing modules 325 and/or to one or more other audio devices (e.g., via the TX/RX module(s) 120). The output signal may be further processed, stored, and/or transmitted by the other processing modules 325 (e.g., as described with reference to FIG. 3).

The desired direction of interference reduction may be to the sides of a main lobe of peak sensitivity of the cardioid-shaped pickup pattern of the first microphone. FIG. 4B shows an example cardioid shape of a pickup pattern 450 of a microphone assembly that only comprises the first microphone. Subtraction of the weighted second audio signal from the first audio signal may result in removal of at least some audio components from the sides of the main lobe of the cardioid pickup pattern of the first microphone. Thus, the generated output signal may correspond to a signal that reflects a narrower cardioid shape than that of the first microphone alone. FIG. 4C shows an example of a narrower cardioid-shaped pickup pattern 455 of a microphone assembly that comprises, in addition to the first microphone, the second microphone located to the side or rear of the microphone assembly (e.g., as described with reference to FIGS. 2A and 2B). In another example, spectral subtraction, as described with reference to FIG. 4A, may result in the microphone assembly having a supercardioid pickup pattern with improved directionality.

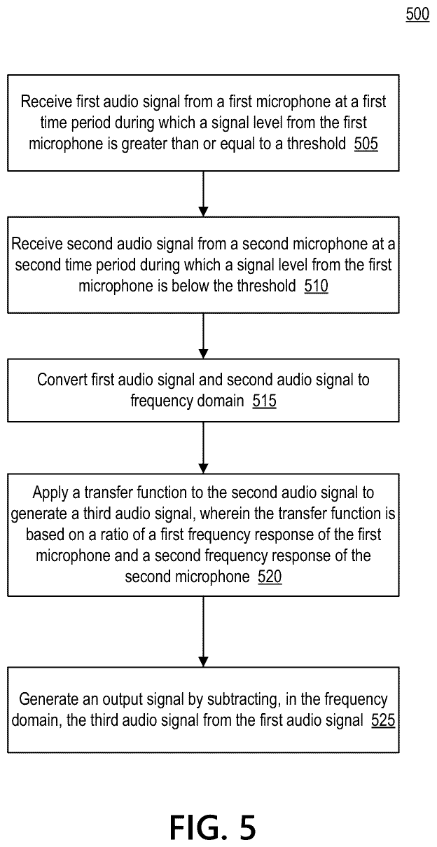

FIG. 5 shows an example method 500 for noise reduction. The noise reduction may be obtained by spectral subtraction of signals picked up by a first microphone (e.g., a condenser microphone, a dynamic microphone, any other microphone with a cardioid or non-cardioid pickup pattern) of a microphone assembly. The subtraction may be performed using signals generated by a second microphone (e.g., a MEMS microphone, any other microphone with an omnidirectional pickup pattern) of the microphone assembly. For example, the first microphone may be a primary microphone (e.g., microphone 215, 255), and the second microphone may be a secondary microphone (e.g., microphone 220, 260). The use of an omnidirectional microphone as the second microphone may enable cancelation of noise as received from any direction relative to the microphone assembly. In an example, the method 500 may be performed by the spectral processing module 315.

At step 505, a processor (e.g., the spectral processing module 315) may receive a first audio signal from the first microphone. The first audio signal may be received at a first time period during which a magnitude (e.g., average magnitude, root mean square (RMS) magnitude) of the first audio signal is greater than or equal to the threshold value. The first audio signal may correspond to a signal measured during a time period during which the microphone assembly is being actively used by a user.

At step 510, the processor (e.g., the spectral processing module 315) may receive the second audio signal from the second microphone. The second audio signal may be received at a second time period during which a magnitude (e.g., average magnitude, RMS magnitude) of the first audio signal is less than a threshold value. The second audio signal may correspond to a noise signal measured at a time period during which the microphone assembly is not being actively used by the user. The second time period may be after the first time period or prior to the first time period.

At step 515, the processor may convert the first audio signal and the second audio signal to the frequency domain. Conversion to the frequency domain may comprise the use of a Fourier transform technique (e.g., DFT, FFT). Y₁(ω) may the frequency domain representation of the first audio signal and Yₙₒᵢₛₑ(ω) may be the frequency domain representation of the second audio signal, where ω=2πf, and f is the frequency.

At step 520, the processor may apply a transfer function k(ω) to the second audio signal Yₙₒᵢₛₑ(ω) to generate a third audio signal Y_{adjusted}(ω). The transfer function k(ω) may be used to match the second audio signal Yₙₒᵢₛₑ(ω) to a first frequency response of the first microphone. The first frequency response of the first microphone H₁(ω) may be in a direction of peak sensitivity of the first microphone (e.g., in front of the first microphone), and the second frequency response H₂(ω) of the second microphone may be in the same direction. In another example, the first frequency response H₁(ω) of the first microphone may be in a direction of detected noise in the second time period, and the second frequency response H₂(ω) of the second microphone may be in the direction of detected noise (e.g., second audio signal) in the second time period. The direction of the detected noise in the second time period may be determined by the source tracker 320 as described with reference to FIG. 3. k(ω) may be determined as:

$$k ( ω ) = \frac{{H}_{1} ( ω )}{{H}_{2} ( ω )} \qquad Equation ( 4 )$$

Accordingly, the third audio signal Y_{adjusted}(ω) may be determined as:

$${Y}_{adjusted} ( ω ) = k ( ω ) {Y}_{noise} ( ω ) \qquad Equation ( 5 )$$

The third audio signal may correspond to an estimated noise that may have been picked up by the first microphone during the first time period.

At step 525, the processor may generate an output signal Yₒᵤₜ(ω) by subtracting the third audio signal Y_{adjusted}(ω) from the first audio signal Y₁(ω). For example, Yₒᵤₜ(ω) may be determined as:

$${Y}_{out} ( ω ) = {Y}_{1} ( ω ) - {Y}_{adjusted} ( ω ) \qquad Equation ( 6 )$$

The processor may send the output signal to the other processing modules 325 and/or to one or more other audio devices (e.g., via the TX/RX module(s) 120). The output signal may be further processed, stored, and/or transmitted by the other processing modules 325 (e.g., as described with reference to FIG. 3).

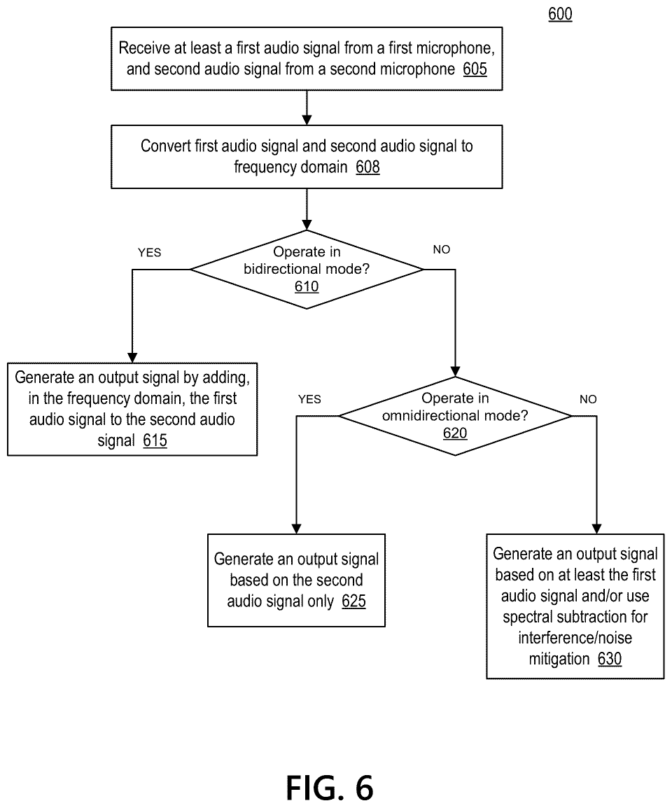

FIG. 6 shows an example method 600 for adjusting a microphone pickup pattern using a spectral addition technique. For example, the method 600 may be used to modify a cardioid pickup pattern of a first microphone (e.g., a condenser microphone, a dynamic microphone, any other microphone with a cardioid pickup pattern) of a microphone assembly using signals generated by a second microphone (e.g., a MEMS microphone, any other type of microphone with an omnidirectional pickup pattern) of the microphone assembly. For example, the first microphone may be a primary microphone (e.g., microphone 215, 255), and the second microphone may be a secondary microphone (e.g., microphone 220, 260). The first microphone and the second microphone may be located on the opposite sides of a microphone assembly. In an example, the method 600 may be performed by the spectral processing module 315.

At step 605, a processor (e.g., the spectral processing module 315) may receive at least a first audio signal from the first microphone and a second audio signal from the second microphone. At step 608, the processor may convert the first audio signal and the second audio signal to the frequency domain. Conversion to the frequency domain may comprise the use of a Fourier transform technique (e.g., discrete Fourier transform (DFT), fast Fourier transform (FFT)). Y₁(ω) may the frequency domain representation of the first audio signal and Y₂(ω) may be the frequency domain representation of the second audio signal, where @=2πf, and f is the frequency.

At step 610, the processor may determine whether the microphone assembly is to operate in a bidirectional (e.g., conversation) mode. The processor may determine to operate in the bidirectional mode based on a user selection via an interface (e.g., switch located on the microphone assembly). Alternatively, the processor may determine to operate in the bidirectional mode based on determining that received audio is originating from two directions. A direction of received audio may be determine by the source tracker 320.

At step 615, and if the processor determines that the microphone assembly is to operate in a bidirectional mode, the processor may generate an output signal Yₒᵤₜ(ω) by spectral addition of the first audio signal and the second audio signal. In this scenario, Yₒᵤₜ(ω) may be determined as:

$${Y}_{out} ( ω ) = {Y}_{1} ( ω ) + {Y}_{2} ( ω ) \qquad Equation ( 7 )$$

At step 620, the processor may further determine whether the microphone assembly is to operate in an omnidirectional mode, for example, if the processor determines that the microphone assembly is not to operate in a bidirectional mode. The processor may determine to operate in the omnidirectional mode based on a user selection via an interface (e.g., switch located on the microphone assembly). Alternatively, the processor may determine to operate in the omnidirectional mode based on determining that received audio is originating from more than two directions.

At step 625, and if the processor determines that the microphone assembly is to operate in an omnidirectional mode, the processor may generate an output signal Yₒᵤₜ(ω) based solely on the second audio signal. In this scenario, Yₒᵤₜ(ω) may be determined as:

$${Y}_{out} ( ω ) = {Y}_{2} ( ω ) \qquad Equation ( 8 )$$

At step 630, and if the processor determines that the microphone assembly is to not operate in an omnidirectional mode (e.g., if the processor determines that microphone assembly is to operate in a unidirectional mode), the processor may generate an output signal Yₒᵤₜ(ω) based solely on the first audio signal. In this scenario, Yₒᵤₜ(ω) may be determined as:

$${Y}_{out} ( ω ) = {Y}_{2} ( ω ) \qquad Equation ( 9 )$$

Alternatively, the processor may apply a spectral subtraction technique (e.g., using signals from the second microphone) for interference reduction and/or noise reduction from the first audio signal (e.g., as described with reference to FIGS. 4A, 4B, 4C, and 5). The processor may determine to operate in a unidirectional mode based on a user selection via an interface (e.g., switch located on the microphone assembly). Alternatively, the processor may determine to operate in the unidirectional mode based on determining (e.g., using the source tracker 320) that received audio is originating from only one direction.

The processor may send the output signal (e.g., as generated at steps 620, 625, or 630) to the other processing modules 325 and/or to one or more other audio devices (e.g., via the TX/RX module(s) 120). The output signal may be further processed, stored, and/or transmitted by the other processing modules 325 (e.g., as described with reference to FIG. 3).

FIG. 7A shows an example method 700 for beamformed audio reception at a microphone assembly. The microphone assembly may comprise a plurality of microphones including at least a first microphone and a second microphone of the microphone assembly. In an example, the first microphone and/or the second microphone may be condenser microphones, dynamic microphones, MEMS microphones, and/or any other type of microphones. For example, the first microphone may be a primary microphone (e.g., microphone 215, 255), and the second microphone may be a secondary microphone (e.g., microphone 220, 260). The second microphone may be located to a side that is away from the direction of a desired audio source to be captured by the first microphone. In an example, the method 700 may be performed by the beamformer 310 and the source tracker 320.

At step 705, one or more processor(s) (e.g., the source tracker 320 and/or the beamformer 310) may receive a first audio signal from the first microphone and a second audio signal from the second microphone. Y₁(ω) may the frequency domain representation of the first audio signal and Y₂(ω) may be the frequency domain representation of the second audio signal, where ω=2πf, and f is the frequency. At step 710, the source tracker 320 may determine, based on the first audio signal and the second audio signal, a direction of audio source.

At step 715, the one or more processors may apply a transfer function k(ω) (e.g., via a filter) to the second audio signal Y₂(ω) to generate a third audio signal Y₃(ω). The transfer function k(ω) may be used to match the second audio signal Y₂(ω) to a first frequency response of the first microphone. The first frequency response of the first microphone may be in the direction of the audio source. For example, if the first frequency response of the first microphone in the direction of the audio source is H₁(ω) and a second frequency response of the second microphone in the direction of the audio source is H₂(ω):

$$k ( ω ) = \frac{{H}_{1} ( ω )}{{H}_{2} ( ω )} \qquad Equation ( 10 )$$

Accordingly, the third audio signal Y₃(ω) may be determined as:

$${Y}_{3} ( ω ) = k ( ω ) {Y}_{2} ( ω ) \qquad Equation ( 11 )$$

Using a transfer function to match the second audio signal to the Y₂(ω) to a first frequency response of the first microphone may enable more accurate beamforming when the first microphone and the second microphone are of different types and/or have different frequency responses.

At step 720, the one or more processors (e.g., beamformer 310) may perform beamforming using the first audio signal Y₁(ω) and the third audio signal Y₃(ω). Performing beamforming may comprise applying time delay(s) to the first audio signal and/or the third audio signal, and combining (e.g., adding) the resultant signals. Magnitude(s) of the time delay(s) may be a function of the source direction. The one or more processors may send an output signal (e.g., as generated based on the beamforming) to the other processing modules 325 and/or to one or more other audio devices (e.g., via the TX/RX module(s) 120). The output signal may be further processed, stored, and/or transmitted by the other processing modules 325 (e.g., as described with reference to FIG. 3).

FIG. 7B shows an example pickup pattern 750 of a microphone assembly that only comprises the first microphone (such as a condenser microphone). FIG. 7C shows an example pickup pattern of a microphone assembly that uses beamforming based on a received signal from the first microphone and a received signal from a second microphone (e.g., another condenser microphone, or any other type of microphone).

Various examples as described herein may use machine learning (ML) and/or artificial intelligence (AI) algorithms for determining a transfer function (e.g., in methods 400, 500, 600, and 700). For example, various machine learning algorithms may be used without departing from the invention, such as supervised learning algorithms, unsupervised learning algorithms, regression algorithms (e.g., linear regression, logistic regression, and the like), instance-based algorithms (e.g., learning vector quantization, locally weighted learning, and the like), regularization algorithms (e.g., ridge regression, least-angle regression, and the like), decision tree algorithms, Bayesian algorithms, clustering algorithms, artificial neural network algorithms, and/or the like. Additional or alternative machine learning algorithms may be used without departing from the invention.

A microphone assembly (e.g., a spectral processing module associated with a microphone assembly) may perform a method comprising multiple operations. The microphone assembly may receive a first audio signal via a first microphone of the microphone assembly. The microphone assembly may further receive a second audio signal via a second microphone of the microphone assembly. The microphone assembly may convert the first audio signal and the second audio signal to frequency domain. The microphone assembly may apply a transfer function to the second audio signal to generate a third audio signal. The microphone assembly may generate an output signal based on subtracting, in the frequency domain, the third audio signal from the first audio signal. The microphone assembly may send the output signal. The transfer function may be based on a ratio of a first frequency response of the first microphone and a second frequency response of the second microphone. The first frequency response and the second frequency response may be in a direction, relative to the microphone assembly, from which interference is to be reduced. The first microphone may have a cardioid-shaped pickup pattern. The first frequency response and the second frequency response may be in a direction perpendicular to the main axis of the cardioid-shaped pickup pattern of the first microphone. The first microphone may be a condenser microphone or a dynamic microphone. The second microphone may be a micro-electromechanical systems (MEMS) microphone. The second microphone may have an omnidirectional pickup pattern. The microphone assembly may convert the output signal to time domain, and send, to a receiving device, the converted output signal. The first microphone has a cardioid-shaped pickup pattern with a first width, wherein the output signal corresponds to supercardioid-shaped pickup pattern with a second width, wherein the second width is less than the first width. The microphone assembly may comprise one or more processors; and memory storing instructions that, when executed by the one or more processors, cause the microphone assembly to perform the described method, additional operations and/or include the additional elements. A system may comprise a microphone assembly comprising one or more processors configured to perform the described method, additional operations and/or include the additional elements; and another device configured to receive the output signal. A computer-readable medium may store instructions that, when executed, cause performance of the described method, additional operations and/or include the additional elements.

A microphone assembly (e.g., a spectral processing module associated with a microphone assembly) may perform a method comprising multiple operations. The microphone assembly may receive a first audio signal via a first microphone, of the microphone assembly, at a first time period. The first time period may be a time period during which a signal level (e.g., a magnitude of the first audio signal) from the first microphone is greater than or equal to a threshold. The microphone assembly may receive a second audio signal via a second microphone, of the microphone assembly, at a second time period. The second time period may be a time period during which the signal level from the first microphone is less than the threshold. The microphone assembly may convert the first audio signal and the second audio signal to frequency domain. The microphone assembly may apply a transfer function to the second audio signal to generate a third audio signal. The microphone assembly may generate an output signal based on subtracting, in the frequency domain, the third audio signal from the first audio signal. The microphone assembly may send the output signal. The transfer function may be based on a ratio of the first frequency response of the first microphone and a second frequency response of the second microphone. The first frequency response and the second frequency response may be in a direction, relative to the microphone assembly, of peak sensitivity of the first microphone. The first frequency response and the second frequency response may be in a direction, relative to the microphone assembly, of the second audio signal in the second time period. The first microphone may have a cardioid-shaped pickup pattern. The first microphone may be a condenser microphone or a dynamic microphone. The second microphone may be a micro-electromechanical systems (MEMS) microphone. The second microphone may have an omnidirectional pickup pattern. The microphone assembly may convert the output signal to time domain; and send, to a receiving device, the converted output signal. The microphone assembly may comprise one or more processors; and memory storing instructions that, when executed by the one or more processors, cause the microphone assembly to perform the described method, additional operations and/or include the additional elements. A system may comprise a microphone assembly comprising one or more processors configured to perform the described method, additional operations and/or include the additional elements; and another device configured to receive the output signal. A computer-readable medium may store instructions that, when executed, cause performance of the described method, additional operations and/or include the additional elements.

A microphone assembly (e.g., a spectral processing module associated with a microphone assembly) may perform a method comprising multiple operations. The microphone assembly may receive a first audio signal via a first microphone of the microphone assembly and a second audio signal via a second microphone of the microphone assembly. The microphone assembly may convert the first audio signal and the second audio signal to frequency domain. The microphone assembly may determine, based on the first audio signal and a second audio signal, that audio is being received, at the microphone assembly, from two directions. The microphone assembly may generate an output signal by adding, in the frequency domain, the first audio signal and the second audio signal. The microphone assembly may send the output signal. The first microphone and the second microphone may be located on opposite ends of the microphone assembly. The microphone assembly may comprise a plurality of microphones other than the first microphone and the second microphone. The determining that the audio is being received from two directions may comprise determining, based on a plurality of audio signals from the plurality of microphones, that audio is being received from two directions. The first microphone or the second microphone may be a condenser microphone, a dynamic microphone, or a micro-electromechanical systems (MEMS) microphone. The first microphone may have a cardioid-shaped pickup pattern. The second microphone may have an omnidirectional pickup pattern. The microphone assembly may comprise one or more processors; and memory storing instructions that, when executed by the one or more processors, cause the microphone assembly to perform the described method, additional operations and/or include the additional elements. A system may comprise a microphone assembly comprising one or more processors configured to perform the described method, additional operations and/or include the additional elements; and another device configured to receive the output signal. A computer-readable medium may store instructions that, when executed, cause performance of the described method, additional operations and/or include the additional elements.

A microphone assembly (e.g., a spectral processing module associated with a microphone assembly) may perform a method comprising multiple operations. The microphone assembly may receive a first audio signal via a first microphone of a microphone assembly and a second audio signal via a second microphone of the microphone assembly. The microphone assembly may determine, based on the first audio signal and a second audio signal, that audio is being received, at the microphone assembly, from more than two directions. The microphone assembly may generate an output signal based only on the second audio signal, and send the output signal. The microphone assembly may comprise a plurality of microphones other than the first microphone and the second microphone. The determining that the audio is being received from more than two directions may comprise determining, based on a plurality of audio signals from the plurality of microphones, that the audio is being received from more than two directions. The first microphone may be a condenser microphone or a dynamic microphone. The second microphone may be a micro-electromechanical systems (MEMS) microphone. The first microphone may have a cardioid-shaped pickup pattern. The second microphone may have an omnidirectional pickup pattern. The microphone assembly may comprise one or more processors; and memory storing instructions that, when executed by the one or more processors, cause the microphone assembly to perform the described method, additional operations and/or include the additional elements. A system may comprise a microphone assembly comprising one or more processors configured to perform the described method, additional operations and/or include the additional elements; and another device configured to receive the output signal. A computer-readable medium may store instructions that, when executed, cause performance of the described method, additional operations and/or include the additional elements.

A microphone assembly (e.g., the beamformer 310 and/or the source tracker 320 associated with the microphone assembly) may perform a method comprising multiple operations. The microphone assembly may receive a first audio signal via a first microphone of the microphone assembly and a second audio signal from a second microphone of the microphone assembly. The microphone assembly may determine, based on the first audio signal and the second audio signal, a direction of audio source. The microphone assembly may apply a transfer function (e.g., filter) to the second audio signal to generate a third audio signal. The transfer function may be based on a ratio of a first frequency response of the first microphone in the direction of the audio source and a second frequency response of the second microphone in the direction of the audio source. The microphone assembly may perform, based on the direction of the audio source, beamforming on the first audio signal and the third audio signal to generate a beamformed audio signal. The microphone assembly may send the beamformed audio signal. The first microphone may be a condenser microphone or a dynamic microphone. The second microphone may be a micro-electromechanical systems (MEMS) microphone. The first microphone may have a cardioid-shaped pickup pattern. The second microphone may have an omnidirectional pickup pattern. The microphone assembly may comprise one or more processors; and memory storing instructions that, when executed by the one or more processors, cause the microphone assembly to perform the described method, additional operations and/or include the additional elements. A system may comprise a microphone assembly comprising one or more processors configured to perform the described method, additional operations and/or include the additional elements; and another device configured to receive the beamformed audio signal. A computer-readable medium may store instructions that, when executed, cause performance of the described method, additional operations and/or include the additional elements.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally, or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

1. A method comprising:
receiving, via a first microphone of a microphone assembly, a first audio signal;
receiving, via a second microphone of the microphone assembly, a second audio signal;
converting the first audio signal and the second audio signal to frequency domain;
applying a transfer function to the second audio signal to generate a third audio signal; and
sending an audio output signal, wherein the output audio signal is based on subtracting, in the frequency domain, the third audio signal from the first audio signal.

2. The method of claim 1, wherein the transfer function is based on a ratio of a first frequency response of the first microphone and a second frequency response of the second microphone.

3. The method of claim 2, wherein the first microphone has a cardioid-shaped pickup pattern, and wherein the first frequency response and the second frequency response are in a direction perpendicular to a main axis of the cardioid-shaped pickup pattern of the first microphone.

4. The method of claim 1, wherein:
the first microphone is a condenser microphone or a dynamic microphone, and
the second microphone is a micro-electromechanical systems (MEMS) microphone.

5. The method of claim 1, wherein the second microphone has an omnidirectional pickup pattern.

6. The method of claim 1, wherein:
the first microphone has a cardioid-shaped pickup pattern with a first width, and
the output audio signal corresponds to supercardioid-shaped pickup pattern with a second width less than the first width.

7. A method comprising:
receiving, via a first microphone of a microphone assembly, a first audio signal at a first time period during which a signal level from the first microphone is greater than or equal to a threshold;
receiving, via a second microphone of the microphone assembly, a second audio signal, at a second time period during which the signal level from the first microphone is less than the threshold;
converting the first audio signal and the second audio signal to frequency domain;
applying a transfer function to the second audio signal to generate a third audio signal;
sending an output audio signal, wherein the output audio signal is based on subtracting, in the frequency domain, the third audio signal from the first audio signal.

8. The method of claim 7, wherein the transfer function is based on a ratio of a first frequency response of the first microphone and a second frequency response of the second microphone.

9. The method of claim 8, wherein the first frequency response and the second frequency response are in a direction, relative to the microphone assembly, of peak sensitivity of the first microphone.

10. The method of claim 8, wherein the first frequency response and the second frequency response are in a direction, relative to the microphone assembly, of the second audio signal in the second time period.

11. The method of claim 7, wherein the first microphone has a cardioid-shaped pickup pattern.

12. The method of claim 7, wherein the second microphone has an omnidirectional pickup pattern.

13. The method of claim 7, wherein:
the first microphone is a condenser microphone or a dynamic microphone, and
the second microphone is a micro-electromechanical systems (MEMS) microphone.

14. A method comprising:
receiving, via a first microphone of a microphone assembly, a first audio signal;
receiving, via a second microphone of the microphone assembly, a second audio signal;
determining, based on the first audio signal and the second audio signal, one or more directions associated with audio being received at the microphone assembly; and
sending an output audio signal, wherein the sending the output audio signal comprises:
based on determining that the audio is being received, at the microphone assembly, from two directions, generating the output audio signal based on the first audio signal and the second audio signal, or
based on determining that the audio is being received, at the microphone assembly, from more than two directions, generating the output audio signal based only on the second audio signal.

15. The method of claim 14, wherein the generating the output audio signal based on the first audio signal and the second audio signal comprises generating the output audio signal by adding, in a frequency domain the first audio signal and the second audio signal.

16. The method of claim 14, wherein the sending the output audio signal comprises, based on determining that the audio is being received, at the microphone assembly, from one direction:
applying a transfer function to the second audio signal to generate a third audio signal;
generating the output audio signal based on subtracting, in a frequency domain, the third audio signal from the first audio signal.

17. The method of claim 14, wherein the first microphone and the second microphone are located on opposite ends of the microphone assembly.

18. The method of claim 14, wherein the microphone assembly comprises a plurality of microphones other than the first microphone and the second microphone, and wherein the determining the one or more directions associated with the audio comprises determining, based on a plurality of audio signals from the plurality of microphones, the one or more directions.

19. The method of claim 14, wherein:
the first microphone is a condenser microphone or a dynamic microphone, and
the second microphone is a micro-electromechanical systems (MEMS) microphone.

20. The method of claim 14, wherein the first microphone has a cardioid-shaped pickup pattern and the second microphone has an omnidirectional pickup pattern.
